(19) United States
(12) Patent Application Publication
(10) Pub. No.: US 2012/0215844 A1
(43) Pub. Date: Aug. 23, 2012

(54) CONNECTING USERS OF A TELECOMMUNICATIONS NETWORK

(76) Inventors: Jure Ferlez, Ljubljana (SI); Ugo Negretto, Munchen (DE)

(21) Appl. No.: 13/030,612

(22) Filed: Feb. 18, 2011

(51) Int. Cl. G06F 15/16

(52) U.S. Cl. 709/204

(57) ABSTRACT

A method for establishing connections between users of a telecommunications network, the telecommunications network comprising a plurality of network devices, the network devices comprising a plurality of user devices and a plurality of network infrastructure devices, comprising: providing a system for establishing said connections; wherein the system performs on one or more of the network devices a semantic analysis and similarity calculation operation on a data item associated with a user so as to ascertain whether the data item has more than a predetermined degree of semantic similarity with other data items associated with other users, and in a case that more than a predetermined degree of semantic similarity is ascertained between the data item and a said other data item, between the user and the user associated with that said other data item, indicating awareness and a possible channel for communication.

The present invention relates to the establishment of connections between users of a telecommunications network.

Currently, when the internet is used for sharing ideas, opinions and knowledge or simply for casual conversation, the connections that are established by a user tend to be influenced by the user's own knowledge and habits. Such connections may result from a pre-existing social relation, such as “friends” in a social networking site, email or instant messaging, or from the websites the user chooses to visit and post messages to.

It is an object of the present invention to establish useful connections between users of a telecommunications network who are unknown to each other and do not necessarily visit the same websites.

With this in mind, according to a first aspect the present invention may provide a method for establishing connections between users of a telecommunications network, the telecommunications network comprising a plurality of network devices, the network devices comprising a plurality of user devices and a plurality of network infrastructure devices, comprising:

providing a system for establishing said connections;
wherein the system performs on one or more of the network devices a semantic analysis and similarity calculation operation on a data item associated with a user so as to ascertain whether the data item has more than a predetermined degree of semantic similarity with other data items associated with other users, and
in a case that more than a predetermined degree of semantic similarity is ascertained between the data item and a said other data item, between the user and the user associated with that said other data item, indicating awareness and a possible channel for communication.

The present invention by means of a semantic analysis and similarity calculation operation is able to ascertain the extent of semantic similarity between a data item associated with a given user and a data item associated with another user and, if warranted, bring those users together, even when they have nothing in common except an interest in certain subject matter.

Preferably, said data item originates from said user. Said data item may be sent from a user device which triggers the performance of the semantic analysis and similarity calculation operation. Alternatively, the user device may send a signal to the system which triggers the performance of the semantic analysis and similarity calculation operation using a data item associated with the user that is already stored in the system.

The semantic analysis and similarity calculation operation may comprise one or more semantic analysis steps followed by a similarity calculation step that does not involve a semantic component. Alternatively, the semantic analysis and similarity calculation operation may comprise a combined semantic analysis and similarity calculation step. An additional data set may be used as part of generalized vector space algorithm to enhance the semantic analysis.

The semantic analysis and similarity calculation operation may take place only between the said data item and selected ones of said other data items selected according to a similarity search algorithm.

The semantic analysis and similarity calculation operation may take place solely on the basis of the said data item and said other data items. Alternatively, the semantic analysis and similarity calculation operation may take place on the basis of the said data item and said other data items, and additionally takes into account information about the past context of a said user.

A said data item may comprise a document. In the context of the present invention, the term “document” is to be construed broadly to include Word or Powerpoint files, emails, webpages, image files and the like. In other embodiments, a said data item may comprise a data stream sent from a user device; the data stream may comprise data collected locally by the user device e.g. picture or video data, and/or data collected by other sensors.

A said document may be dynamically updated based on the document access pattern of the originating user. For example, as the user originating said document moves onto a new document, the new document replaces the earlier document. Dynamic updating of said documents is used in applications in which it is desired to establish a connection between users based on their currently accessed document. Application 1 as described later is an example of such an application.

A said document may be static.

In some embodiments, the said document is a document constructed by a said user. The document is constructed with content aimed at establishing contact with a target group of other users. A user may construct one or more of such documents. User-defined static earlier documents have many applications. Application 2 as described later is an example of such an application.

In some embodiments, the said document is a document resulting from the document access pattern of the originating user. But rather than being replaced as the user moves onto a new document, the new document is added to the set of earlier ones of said documents. As the static content reaches a certain age, it may be discarded/deleted.

The indication of awareness and a possible channel for communication is preferably achieved by means of a service client that supports a graphical user interface (GUI) for one user.

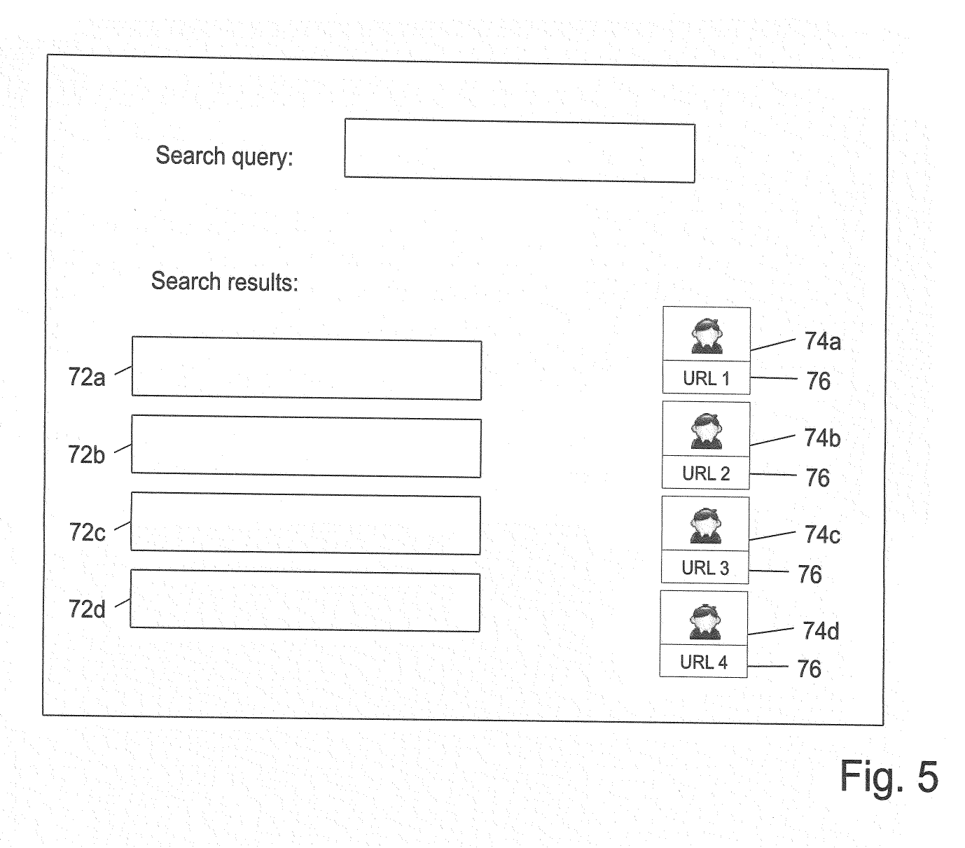

Said indication may comprise displaying an avatar/icon. The display of the avatar/icon may indicate both the awareness of the existence of a said other user (i.e. one deemed to be in the information space of said one user) and the possibility of chat with that said other user. Alternatively, the display of the avatar may indicate just the awareness of the existence of that said other user and an icon for chat indicates the availability of the chat channel of communication. The availability of other channels for communication may be indicated by their own icon. The communication modes include one-to-many and one-to-one channels. The avatar may be displayed in a predetermined control region of the GUI or alternatively at a location depending on the semantic content of the document. An example of the latter approach is shown in FIG. 5.

In one embodiment, associated with an avatar displayed to represent a said other user, there is a hyperlink pointing to where the said other user is currently accessing a said document. Thus, this embodiment provides a user-friendly way of not only connecting with another user but also the document that that user is currently accessing. In other embodiments, the hyperlink may be present without an avatar/icon.

Preferably, the said avatar/icon is displayed in a selected one of a plurality of formats. The selection of the format depends on the situation and the application. The format used may be indicative of the status of a said other user and/or of the nature of the compared data items and/or the result of the similarity calculation. For example, a larger avatar/icon may be used to represent a said other user which is merely deemed to be in the information space of a said user. Whereas, a smaller avatar/icon may be used to represent a said other user which is deemed to be in the information space of a said user and which by virtue of its status and/or the nature of the application is deemed to have an interest in the information space of said user.

The system may be realised in a client-server architecture or a peer-to-peer architecture.

According to the client-server architecture, the system comprises a server infrastructure for performing the semantic analysis and similarity calculation operation. According to the peer-to-peer architecture, the semantic analysis portion of the semantic analysis and similarity calculation operation is performed in a distributed way (via exchange of results of semantic analysis and/or similarity calculations) over a plurality of further user devices that are known to one user.

According to a second aspect, the present invention may provide a system for establishing connections between users of a telecommunications network, the telecommunications network comprising a plurality of network devices, the network devices comprising a plurality of user devices and a plurality of network infrastructure devices,

wherein the system performs on one or more of the network devices a semantic analysis and similarity calculation operation on a data item associated with a user so as to ascertain whether the data item has more than a predetermined degree of semantic similarity with other data items associated with other users, and
in a case that more than a predetermined degree of semantic similarity is ascertained between the data item and a said other data item, between the user and the user associated with that said other data item, indicating awareness and a possible channel for communication.

According to a third aspect, the present invention may provide a server infrastructure for a system for establishing connections between users of a telecommunications network, the telecommunications network comprising a plurality of network devices, the network devices comprising a plurality of user devices and a plurality of network infrastructure devices,

wherein the server infrastructure is operable to perform a semantic analysis and similarity calculation operation on a data item associated with a user so as to ascertain whether the data item has more than a predetermined degree of semantic similarity with other data items associated with other users, and
in a case that more than a predetermined degree of semantic similarity is ascertained between the data item and a said other data item, between the user and the user associated with that said other data item, indicating awareness and a possible channel for communication.

According to a fourth aspect, the present invention may provide a service client suitable for use in the system according to the second aspect.

According to a further aspect, the present invention may provide a method of performing sales according to the first aspect, wherein a said document comprises a sales offer document that is static. According to a further aspect, the present invention may provide a system for performing sales comprising a system according to the second aspect deployed to establish connections between buyers and sellers, wherein a said document comprises a sales offer document that is static.

Exemplary embodiments of the present invention are hereinafter described with reference to the accompanying drawings, in which:

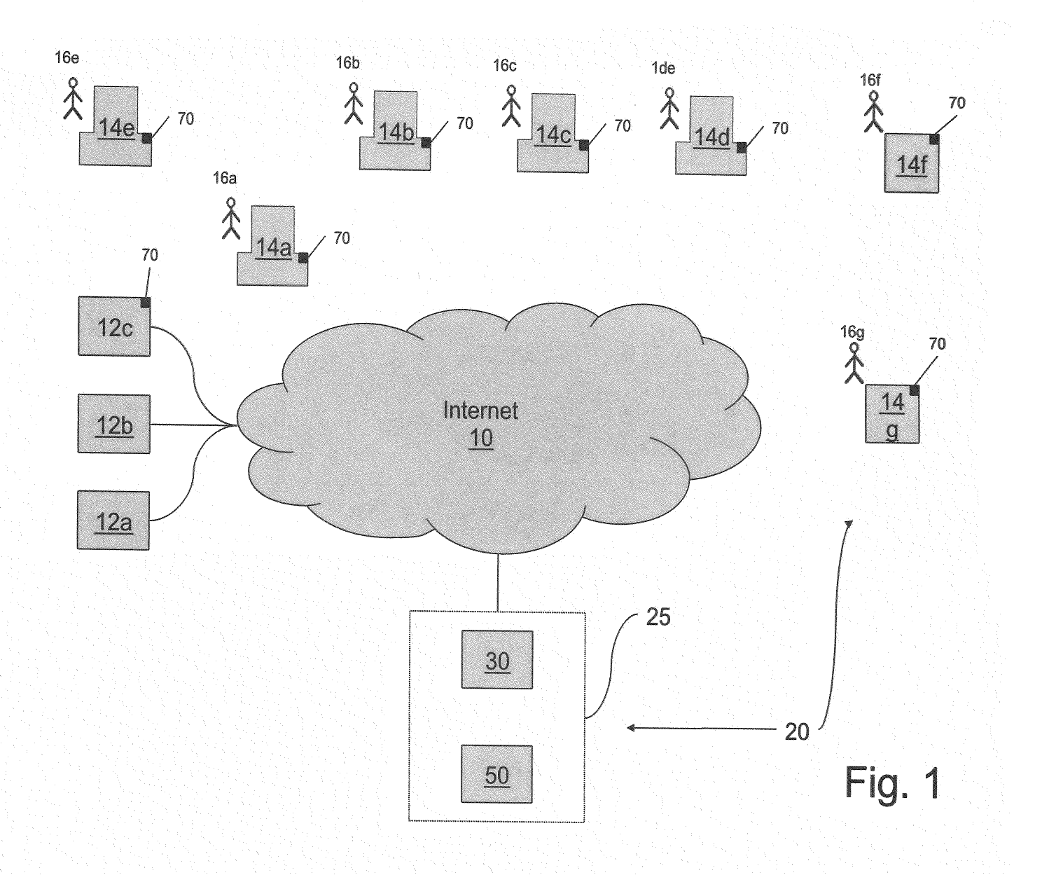

FIG. 1 shows a diagram of a telecommunications network;

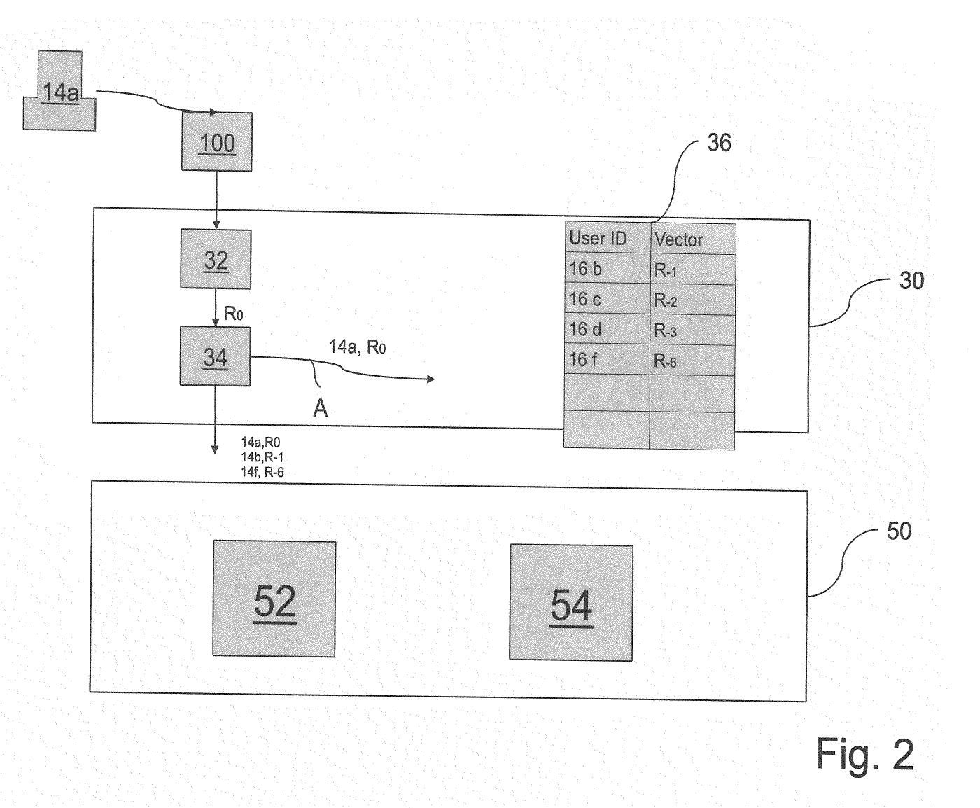

FIG. 2 shows a diagram of one embodiment of a server infrastructure forming part of the telecommunications network;

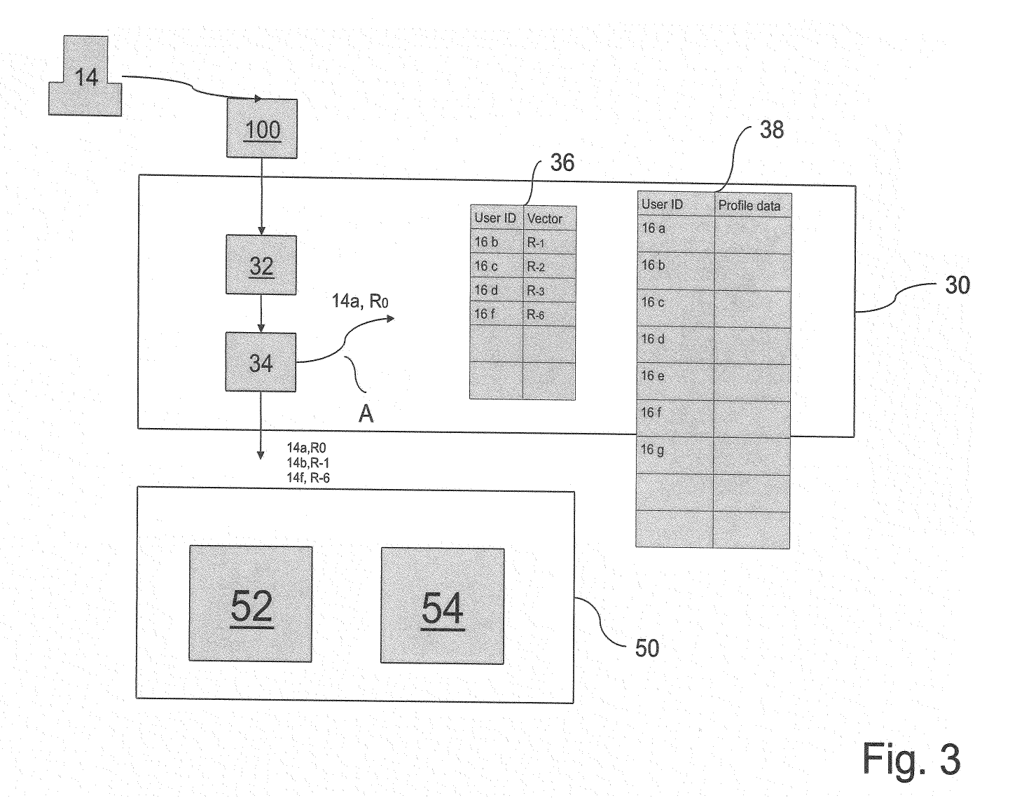

FIG. 3 shows a diagram of an alternative embodiment of a server infrastructure forming part of the telecommunications network;

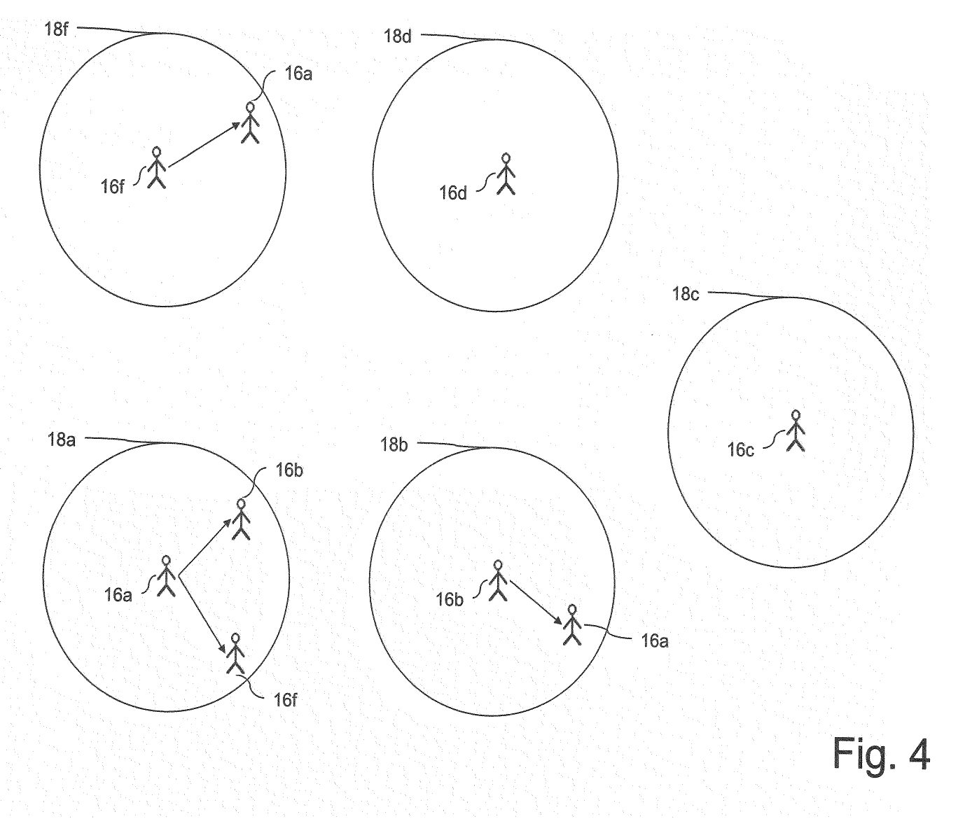

FIG. 4 show a diagram illustrating the state of collaboration amongst users;

FIG. 5 shows a diagram illustrating part of the GUI following a search query;

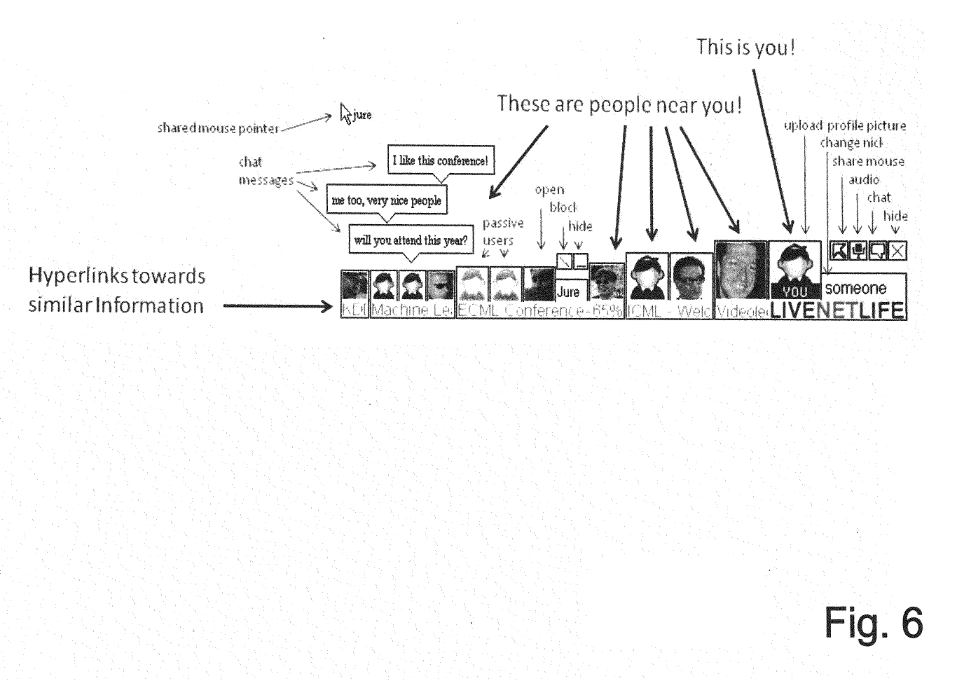

FIG. 6 shows a view of chat between one user and other users deemed to be in that one user's information space;

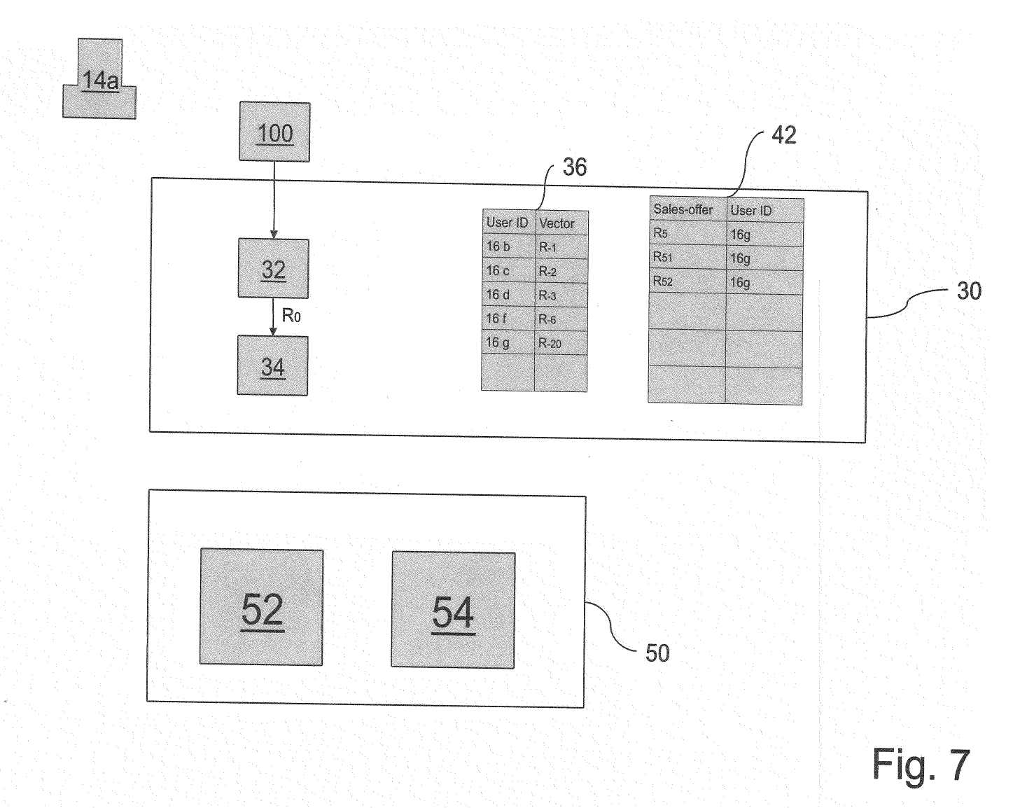

FIG. 7 shows a diagram of a further alternative embodiment of a server infrastructure forming part of the telecommunications network; and

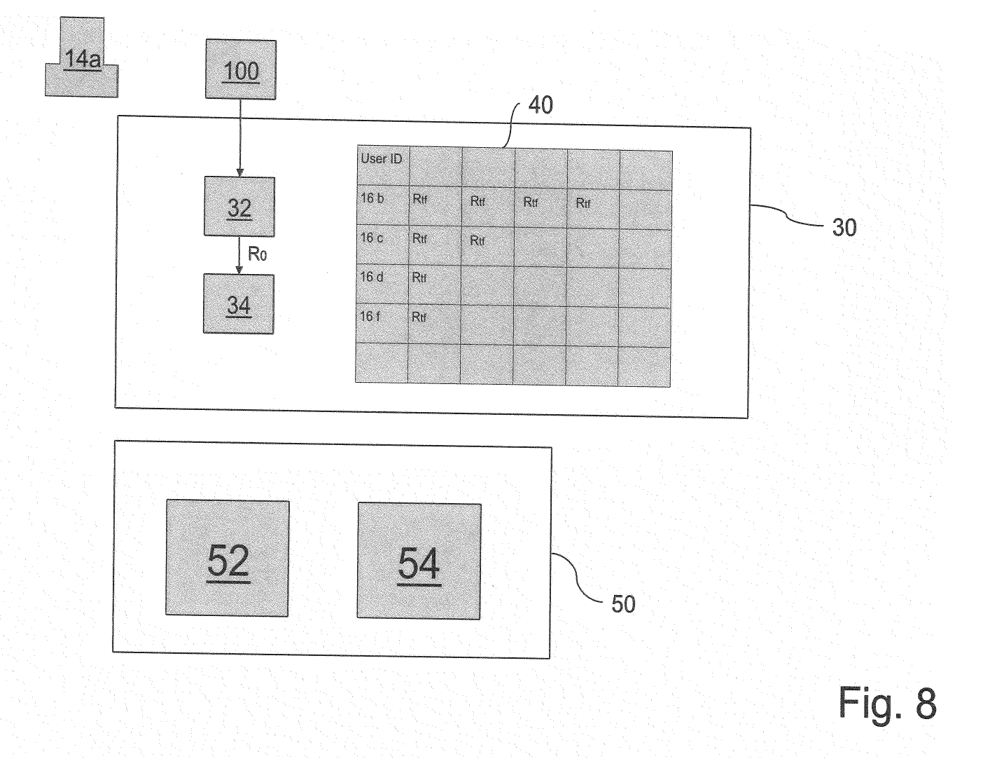

FIG. 8 shows a diagram of a still further alternative embodiment of a server infrastructure forming part of the telecommunications network.

Throughout this description the same or corresponding parts have been given the same or corresponding reference numerals.

A telecommunications network 10 comprising the internet is shown in FIG. 1. The telecommunications network 10 comprises a plurality of network infrastructure devices including a plurality of content servers 12 and a plurality of user terminal devices 14 by which users 16 access documents, e.g. webpages on websites, on the servers 12. In FIG. 1, representative example servers 12a-c, representative example user terminal devices comprising PC's 14a-e, representative example user terminal devices comprising mobile phones 14f-g, and representative example users 16a-g are illustrated.

The telecommunication network 10 further comprises a system 20 by which connections between users who are unknown to each other and do not necessarily visit the same websites may be established. The system comprises a server infrastructure 25 comprising a meaning-and-similarity server 30 and a presence-and-collaboration server 50, and a plurality of service clients 70.

The core architecture and functionality of the system 20 is now described with reference to FIGS. 1 to 4.

In an embodiment shown in FIG. 2, the meaning-and-similarity server 30 comprises a meaning processing module 32 which takes as its input a document 100 originated from a user terminal device and performs a semantic analysis of its textual content. As an example, it will be assumed that the document 100 is originated from the terminal device 14a which is unknown to the server infrastructure 25. The module 32 uses known text mining techniques such as lemmatization, stop word elimination, entity extraction, bag-of-words representation, generalized vector spaces, word sense disambiguation and dimensional reduction. In one embodiment, a two-stage semantic analysis is performed. In a first stage of semantic analysis, a bag-of-words vector representation of the document 100 is calculated. Then, in a second stage of semantic analysis, the bag-of-words vector representation is correlated with an existing large repository of reference text, e.g. an encyclopaedia, to calculate a multi-dimensional vector constituting an absolute numerical representation R₀ of the semantic meaning of the content of the document 100. The meaning-and-similarity server 30 further comprises a similarity ascertaining module 34 which takes as its input the numerical representation R₀ generated by the module 32 in respect of the document 100 and performs a similarity calculation between R₀ and a set of numerical representations stored in a current-user table 36, each member of the set resulting from a semantic analysis of an earlier (than the document 100) document supplied to the meaning-and-similarity server 30 by other user terminal devices. When the number of users is relatively small, a similarity calculation may be performed between R₀ and each member of the set in turn. When the number of users is larger, it is preferred that the similarity ascertaining module 34 uses a similarity search technique, e.g. triangular inequality, to enable the similarity calculation to be performed between R₀ and only selected members of the set. The similarity calculation comprises simply calculating the cosine of the angle between R₀ and the stored numerical representation. The larger the result, the greater the similarity that may be inferred. Representative examples R₋₁, R₋₂, R₋₃, and R₋₆ are shown. In respect of each stored numerical representation, identification data indicating the user who is using the originating terminal device of the corresponding earlier document is also stored. For each case, where the similarity calculation reveals more than a predetermined degree of semantic similarity between the numerical representation R₀ and a stored numerical representation, the users of the terminal devices which originated the corresponding documents are deemed to be in the information space of the user 16a. It will be appreciated that due to the semantic analysis that is performed, one user can be deemed to be in the information space of another user when they have not seen the same document or browsed the same website. As indicated by the arrow A, the data for user 16a, namely the identification data and the numerical representation R₀, is added to the current-user table 36.

In alternative embodiment shown in FIG. 3, the meaning-and-similarity server 30 differs from that shown in FIG. 2 in that the meaning-and-similarity server 30 further comprises a user-profile table 38. The user-profile table comprises an entry for all known users of the system whether currently active or not. For each entry in the table 38, as well as the identification data indicating the user of a terminal device, there is profile data corresponding to the user. The profile data provides an indication of the historical contexts in which the user operates. In this embodiment, the meaning processing module 34 takes as its input not only the document 100 but also the profile data for the user device 14a to produce the numerical representation R₀. In this way, knowledge about a particular user's past activity can be used to inform the semantic meaning ascribed to the current document 100. In one simple example, the profile data can comprise a list of the most commonly occurring lexemes extracted from the user's previously accessed documents. On the basis of the conjecture that the more frequently a lexeme occurs the less indicative of context it is (for example, if a user is a dentist the occurrence of the lexeme tooth/teeth will not be a meaningful indicator of meaning), then the profile data can be fed into stop word elimination step of the semantic analysis so as to not only remove general stop words like “to”, “and” and the like, but also words corresponding to the most commonly occurring lexemes for the user. In this way, the semantic analysis can be made more meaningful by additionally reflecting the historical contexts in which the user of the terminal device operates.

As a variant on the FIG. 2 or FIG. 3 embodiments, instead of performing one or more steps of semantic analysis followed by a similarity calculation that does not involve any semantic analysis, a first stage of semantic analysis is performed to calculate a bag-of-words vector representation of the document 100 and then a second stage comprising a combined semantic analysis (providing correlation with an existing large repository of reference text) and similarity calculation (with respect to one of the numerical representations stored in the current-user table 36) is performed.

For both the FIG. 2 or FIG. 3 embodiments, identification data for the user 16a and identification data for any user is deemed to in the information space of the user 16a of the terminal device 14a is sent to the presence-and-collaboration server 50. As an illustration, it is shown in FIGS. 2, 3 that the users 16b,f have been determined to be in the information space of the user 16a, and, as a result, as well as the identification data for the user 16a, the identification data for the users 16b,f are sent to the presence-and-collaboration server 50.

The presence-and-collaboration server 50 provides real-time presence and multi-mode collaboration based on the open source XMPP server module, for example, Openfire. By means of a first module 52, presence identification is performed by continuously monitoring the activity of the known users. In particular, the first module 52 analyses whether a known user is active, tracks on which document s/he is and builds a relation to the document content. By means of a second module 54, collaboration is performed. For each known user 16a-g, a room 18a-g for collaboration is opened which is configured such that only that user is an active member for the room and thus permitted to communicate actively, whereas other guest members of the room are limited to receiving the communication of the active member. Referring to FIG. 4, based on the data received from the meaning-and-similarity server 30, a room 18a for the user 16a of terminal device 14a is opened in which only that user is an active member (depicted at the centre of the room 18a) permitted to communicate actively, and the users 16b,f of terminal devices 14b,f are installed as guest members (depicted at the periphery of the room 18a) limited to receiving that communication. In addition, the user 16a of terminal device 14a is installed as a guest member in each of the rooms in which the users of terminal devices 14b,f respectively had earlier been installed as the active member, i.e. the rooms 18b,f. It will be appreciated that in the state shown in FIG. 4 prior to the arrival of user 16a, none of the current existing users 16b,c,d,f had been determined to be in the information space of another user. As described later in more detail, through the use of collaboration rooms in this manner, two-way communication between users can be achieved. The collaboration rooms provided by the second module 52 provide chat (i.e. instant messaging) functionality. In addition, the second module 52 may also configure the terminal devices to stream audio, video, mouse control data to predetermined URLs to enable voice, video and mouse-following functionality to be also supported.

In other embodiments, the meaning-and-similarity server 30 and the presence-and-collaboration server 50 functions can be performed on the same server machine or alternatively distributed over more than two server machines, for example, in a large-scale system.

The service client 70 provide the client-side functionality and is based on an Ajax-based graphical user interface (GUI). The client 70 performs the capturing of the textual content that the user is accessing and sends that to the server infrastructure 25 for processing as described above. The client 70 for one user displays the other users that have been determined to be in the information space of that one user. In other words, taking the terminal device 14a and the FIG. 4 state as an example, the client 70 on the terminal device 14a presents, for the user 16a via an intuitive GUI, (i) the other users that have been identified by the meaning-and-similarity server 30 as being in the information space of the user 16a, and (ii) the communication resources that have been set-up and allocated by the presence-and-collaboration server 50 to allow communication between the user 16a and those other users. The GUI uses avatars embedded in the documents. The GUI presents an avatar that represents the user 16a him-/herself and indicates awareness of the existence of other users 16b,f that have been determined to be in the information space of the user 16a by displaying avatars corresponding to those users. The size of the avatar may represent the degree of similarity determined by the similarity calculation. The GUI also indicates through which communication channels the user 16a may communicate with these other users 16b,f. Normally, at least chat would be provided by the presence-and-collaboration server 50.

FIG. 5 shows a diagram illustrating part of the GUI following a search query by, say, the user 16a. The search engine produces a series of results. Results 72a-d are shown as representative examples. The system 20, as described above, then identifies other users that are deemed to be in the information space of the user 16a as ascertained with respect to each of the search results individually. For those users deemed to be in the information space of user 16a with respect to an item of content, an avatar 74a-d and having an embedded link to a URL 76 pointing to where those users are currently viewing a document, is associated with the individual search result. A search result may correspond to a static data item associated with, and pre-posted in the system by, a particular user. When that user is not a current user of the system, he may be “poked” via an alert by email or SMS, for example. In the example shown, there happens to be a single user associated with each search result. There may, of course, be no avatar or more than one avatar associated with a given search result depending on the search result and the activity of the other users.

The service client 70 can be deployed in at least 4 ways.

In one embodiment, the client 70 comprises a page plugin which is embedded within a webpage. This embodiment allows the service provided by the system 20 to be deployed via the server of a web publisher. The web publisher may configure if the service is configured to operate with any online user or only for a subset. The subset may comprise users only from its own website, or users from other “friendly” or affiliated websites or particular individual users who are not browsing at any particular website. The page plugin makes each visitor to the server of the web publisher a user 16 of the system 20. The publisher may configure the type and amount of communication channels, for example, chat, audio, video, page following, mouse sharing and the like, which are automatically enabled as a default for the visitor and what information is viable.

In one embodiment, the client 70 comprises a browser plugin which is installed in a user's web browser. As a result, the service provided by the system 20 is available to the user 16 at every webpage that the user visits. The browser plugin may be installed into Firefox, Internet Explorer, Chrome or any other extensible web browser. The browser plugin can be configured or personalized in a similar manner to the page plugin.

In one embodiment, the client 70 comprises an application extension. For example, an add-in into Microsoft Office applications like Word, Powerpoint, Outlook at the user level. As a result, the service provided by the system is available on each word processing document, email or presentation that the user opens, since the meaning-and-similarity server 30 is able to perform the similarity calculation on the basis of the textual or other content of that document.

In one embodiment, the client 70 comprises a plugin for a chat (i.e. instant messaging) client. The chat client can be in a mobile device or a PC. Alternatively the client 70 comprises a chat buddy added into the user's chat roster of friends. In one embodiment, the system appears as a friend, for example who is called “LNLFriend”, of the user. The system can be used to receive and send messages to the LNLFriend. Communication with other users happens either directly or indirectly through LNLFriend or directly with explicit chat rooms, voice or videos in the chat client.

The operation of the system 20 as described above and further features of the system 20 are now explained with reference to a number of different applications.

### Application 1—Anonymous, Real-Time (Social) Network Formation

In this application, the telecommunications network 10 comprises the whole internet and the user terminal device is equipped with a browser plugin.

If the user 16a goes online in order to perform a specific task, like, for example, to book a holiday in Greece, or find out certain information about Greek history, then upon visiting a Greece-related website, the client 70 in the user terminal device 14a transmits that webpage to the server infrastructure 70 for processing. At the meaning-and-similarity server 32, other currently-online users who are also viewing documents concerning Greece, Greek holidays, or Greek history, whatever the information space of the user 16a is determined to be in this particular case, are identified as described above. Then, the presence-and-collaboration server 50 configures the collaboration resources, i.e. the collaboration rooms 18a, so as to make connections between the user 16a and the other relevant users possible and then passes this information to the client 70. The client 70 then makes the user 16a aware of the existence of the other relevant users and provides an indication of the possible channels that are available for interaction. The clients 70 of the other relevant users perform a similar role. In this way, people having nothing in common except some interest in Greece may be brought together as an ad-hoc social network.

FIG. 6 shows an example of the avatar-based GUI of the client of the user 16a (“You”). The avatar acts as the interface allowing the user to access the communication channels that enable interaction. The degree of similarity between the user 16a and another of the relevant users may be shown by the relative size of the avatars as shown in FIG. 6 or by a bubble that displays the degree of similarity. Each avatar has a link attached to it which gives the URL address where its user is browsing at that moment in time. Through this means, the possibility is created of page following, i.e. following an avatar to the webpage which its user is currently looking at. This course of action could be suggested by voice or chat for the purpose of inviting one or more users to share the content that he is accessing. When two or more users are sharing the same content, the mouse sharing functionality may be activated in order to facilitate explanations between users.

In one embodiment, a given user can choose between 4 possible service states: off, invisible, passive, and active. Whereas “off” turns off the service completely, “invisible” means the service is running but the given user is not visible to other users who are visible to the given user, “passive” means the service is running and the given user cannot be contacted but is visible to other users, and finally “active” defines that the service is running and the given user can been seen from any other user that has previously been determined to be in the given user's information space or vice versa.

The interaction between users may be kept entirely anonymous. Alternatively, personalization of the avatar with a name and/or a picture is possible. Chats are built up in analogous manner to those in comic books where the text is displayed in bubbles. In this GUI the text is volatile (i.e. disappears after a short period of time). The time of persistence and the look-and-feel can be customised.

In a variant of the above application, the service could be run by a site owner or web publisher. In this scenario, a webpage plugin is deployed and the telecommunications network 10 comprises only those websites that are controlled by or affiliated to the site owner or the web publisher. Within these sites, the service operates the same as described above.

In Application 1, the system 20 may comprise a meaning-and-similarity server 30 according to either the FIG. 2 or FIG. 3 configuration.

In this application, as one user, for example, the user 16b, moves from one webpage to another, as the new webpage is transmitted to the server infrastructure 25 as document 100, in addition to the above-described process, the numerical representation R₀ replaces the vector that had been calculated for the previous webpage in the current-user table 36, for example, R₋₁ in the state shown in FIG. 2. In this way, the current-user table 36 is dynamically updated.

### Application 2—Contextual Sales

In this application, the telecommunications network 10 comprises the whole internet and the user terminal devices are equipped with a chat plugin.

In terms of the GUI that is presented to the users, the GUI for this application may be generally similar to that presented in relation to Application 1 above.

In this application, the meaning-and-similarity server 30 differs from that shown in FIG. 2 in that the meaning-and-similarity server 30 further comprises a sales-offer table 42. The sales-offer table 42 contains a list of all the sales offers that have been posted on the system.

An offer may be posted on the system 28 by a user preparing the offer in a Word or Powerpoint document and then through the client GUI marking the document as a sales offer. This causes the document to be sent to the server infrastructure 20 where it is processed by the meaning-and-similarity server 30 as a sales offer document. Alternatively, an offer may be posted on a website and an association created between the posted offer and the server infrastructure 20. In either case, the meaning processing module 32 performs a semantic analysis of the textual content of the sales offer document and calculates an absolute numerical representation Rₛ of the semantic meaning of the sales offer document. The numerical representation Rₛ and identification data indicating the user posting the offer make up an entry in the sales-offer table 42.

In this embodiment, the similarity ascertaining module 34 performs a similarity calculation not only between the numerical representation R₀ of the current document and each member of a set of numerical representations stored in the current-user table 36, but also between R₀ and the numerical representations contained in the sales-offer table 42. It will be appreciated that while the information in the current-user table 36 is relatively dynamic depending as it does on a user being a current user of the service, the information in the sales-offer 42 is static as it is held regardless of whether the seller remains a current user of the service or not.

Thus, taking the example shown in FIG. 7 in which the user 16g has previously posted one or more sales offers and similarity in semantic meaning has been identified between the current document 100 which the user 16a is browsing on his terminal device 14a, then, as is discernable from the current-user table 36, the seller 16g via the chat client on his mobile phone is a current user of the service and so mutual awareness and the available communication options are indicated generally as explained in relation to Application 1. In this application, however, rather than as a regular user, the seller 16g is treated differently by the GUI and displayed in conjunction with a seller icon button. If the seller 16g were not a current user of the service, for example, if his chat client were switched off, an alert is sent via an email or an SMS (The telephone number and email address form part of the user's basic service profile information).

In this way, the seller is notified of the presence of an active user, who is a neighbour in content and thus a potential buyer, even when that potential buyer has not even seen the sales offer or may not even be browsing in a sales context. The seller can then connect to the network via an available terminal device, in this example a mobile phone, and establish a connection with the potential buyer.

In Application 2, the system 20 may comprise a meaning-and-similarity server 30 according to either the FIG. 2 or FIG. 3 configuration.

### Application 3—Knowledge Worker Collaboration

In this application, the telecommunications network 10 comprises the intranet of a large company and the knowledge worker users use an extension like page, browser or office plugin.

In terms of the GUI that is presented to the users, the GUI for this application may be generally similar to that presented in relation to Application 1 above.

However, for this application, rather than comparing only the documents that a given pair of users are viewing at a given moment, it is preferred that the window of comparison be extended to a longer time frame, for example, in the order of days or perhaps as long as a month.

Referring to FIG. 8, in this application, the meaning-and-similarity server 30 differs from that shown in FIG. 2 in that the current-user table 36 is replaced with an existing-user table 40. For each entry in the existing-user table 40, as well as the identification data indicating a user, there are a plurality of fields containing numerical representations R_{tf} of the semantic meanings of all the documents that the user has accessed in a given time frame. In this embodiment, the meaning processing module 32 takes as its input the document 100 to produce the numerical representation R₀. Then, the similarity ascertaining module 34 performs a similarity calculation between R₀ and each of the earlier calculated numerical representations R_{tf} for each of the users listed in the existing-user table 40. For each case, where the similarity calculation reveals more than a predetermined degree of similarity between the numerical representation R₀ and a stored numerical representation, the other users of the terminal devices which supplied the corresponding documents are deemed to be in the information space of the user 16a.

Thus, in the case, that the document 100 is supplied by the user 16a and the users 16b,f have recently accessed documents that put them in the same information space, the user 16a of the terminal device 14a is made aware of this by avatars representing the users 16b,f. The avatars have associated with them hyperlinks to the relevant documents. The avatars with the associated links are superimposed onto the relevant portions of the document 100. If the users 16b,f are currently online, then communication options similar to those explained in relation to Application 1 are signalled as being available. If the users 16b,f are not currently online, by sending an email alert (the email address forms part of the user's basic service profile information).

In this way, knowledge workers within a single organisation but not formally in any common teams or projects may be brought together for possible collaboration only on the basis of the documents that they access.

In Application 3, the system 20 may comprise a meaning-and-similarity server 30 according to either the FIG. 2 or FIG. 3 configuration. A configuration according to FIG. 3 builds a profile of the knowledge worker which can be used to enhance the semantic similarity measure calculation, i.e. extension of the stop words set. In such a configuration, it is preferred that the avatar/icon that is used to indicate awareness and a possible channel for communication differs depending on the situation. In the situation that another user is viewing a document similar to user 16a, then a regular avatar is used. In the situation that another user is viewing a document that is in the history of the user 16a, then a small icon is used. Upon clicking upon the icon, communication channels like chat, email and SMS are made available.

In a further embodiment of the present invention, the document 100 may comprise a picture. In this embodiment, the picture is pre-processed using an API for Google's Goggle service which converts the image into a string of explanatory text and this text is processed by the server infrastructure 25 as previously described.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

### LIST OF PARTS

telecommunications network 10
content servers 12, 12a-c
terminal devices, PCs, mobile phones 14, 14a-g
users 16, 16a-g
rooms 18, 18a-g
system 20
server infrastructure 25
meaning-and-similarity server 30
meaning processing module 32
similarity ascertaining module 34
current-user table 36
user-profile table 38
existing-user table 40
sales-offer table 42
presence-and-collaboration server 50
first module 52
second module 54
service client 70
search results 72a-d
avatars 74a-d
URL 76
document 100

1. A method for establishing connections between users of a telecommunications network, the telecommunications network comprising a plurality of network devices, the network devices comprising a plurality of user devices and a plurality of network infrastructure devices, comprising:
providing a system for establishing said connections;
wherein the system performs on one or more of the network devices a semantic analysis and similarity calculation operation on a data item associated with a user so as to ascertain whether the data item has more than a predetermined degree of semantic similarity with other data items associated with other users, and
in a case that more than a predetermined degree of semantic similarity is ascertained between the data item and a said other data item, between the user and the user associated with that said other data item, indicating awareness and a possible channel for communication.

2. The method according to claim 1, wherein said data item originates from said user.

3. The method according to claim 1, wherein the semantic analysis and similarity calculation operation takes place solely on the basis of said data item and said other data items.

4. The method according to claim 1, wherein the semantic analysis and similarity calculation operation takes place on the basis of the said data item and said other data items, and additionally takes into account information about the past context of a said user.

5. The method according to claim 3, wherein the semantic analysis and similarity calculation operation includes the step of using an additional knowledge base or data set, for instance via a generalized vector space algorithm.

6. The method according to claim 1, wherein a said data item comprises a document.

7. The method according to claim 6, wherein said data originates from said user and said document is dynamically updated based on the document access pattern of said user that originates the document.

8. The method according to claim 6, wherein the said document is static.

9. The method according to claim 8, wherein the said document is a document constructed by said user, i.e. predefined by said user.

10. The method according to claim 8, wherein one or more of said documents are generated from the document access pattern of said user that originates the document(s).

11. The method according to claim 1, wherein a service client on one said user device provides an indication of awareness and a possible channel for communication via a graphical user interface (GUI).

12. The method according to claim 11, wherein said indication comprises displaying an avatar/icon.

13. The method according to claim 12, wherein the avatar/icon is displayed at a location within the document depending on the semantic content of the document or other location markers such as URLs or meta data.

14. The method according to claim 12, wherein associated with said avatar/icon displayed to represent a said other user, there is a hyperlink pointing to where the said other user is currently accessing a said document.

15. The method according to claim 12, wherein the avatar/icon is displayed in a selected one of a plurality of formats.

16. The method according to claim 1, wherein the system comprises a server infrastructure for performing the semantic analysis and similarity calculation operation.

17. A system for establishing connections between users of a telecommunications network, the telecommunications network comprising a plurality of network devices, the network devices comprising a plurality of user devices and a plurality of network infrastructure devices,
wherein the system comprises means for performing on one or more of the network devices a semantic analysis and similarity calculation operation on a data item associated with a user so as to ascertain whether the data item has more than a predetermined degree of semantic similarity with other data items associated with other users, and
in a case that more than a predetermined degree of semantic similarity is ascertained between the data item and a said other data item, between the user and the user associated with that said other data item, indicating awareness and a possible channel for communication.

18. A server infrastructure for a system for establishing connections between users of a telecommunications network, the telecommunications network comprising a plurality of network devices, the network devices comprising a plurality of user devices and a plurality of network infrastructure devices,
wherein the server infrastructure includes means for performing a semantic analysis and similarity calculation operation on a data item associated with a user so as to ascertain whether the data item has more than a predetermined degree of semantic similarity with other data items associated with other users, and
in a case that more than a predetermined degree of semantic similarity is ascertained between the data item and a said other data item, between the user and the user associated with that said other data item, indicating awareness and a possible channel for communication.

19. A service client suitable for use in the system according to claim 17.

20. Software products for the system for performing the method of claim 1.

21. The method according to claim 2, wherein the semantic analysis and similarity calculation operation takes place solely on the basis of said data item and said other data items.

22. The method according to claim 2, wherein the semantic analysis and similarity calculation operation takes place on the basis of the said data item and said other data items, and additionally takes into account information about the past context of a said user.

23. The method according to claim 4, wherein the semantic analysis and similarity calculation operation includes the step of using an additional knowledge base or data set, for instance via a generalized vector space algorithm.

24. The method according to claim 9, wherein one or more of said documents are generated from the document access pattern of said user that originates the document(s).

25. The method according to claim 13, wherein associated with said avatar/icon displayed to represent a said other user, there is a hyperlink pointing to where the said other user is currently accessing a said document.

26. The method according to claim 11, wherein
said indication comprises displaying an avatar/icon;
the avatar/icon is displayed at a location within the document depending on the semantic content of the document or other location markers such as URLs or meta data;
associated with said avatar/icon displayed to represent a said other user, there is a hyperlink pointing to where the said other user is currently accessing a said document;
the avatar/icon is displayed in a selected one of a plurality of formats.
